(19) United States
(12) Patent Application Publication
(10) Pub. No.: US 2009/0194719 A1
(43) Pub. Date: Aug. 6, 2009

(54) FLUID SUPPLY MONITORING SYSTEM

(76) Inventor: Timothy David Mulligan, Saline, MI (US)

Correspondence Address: Masco Corporation, 21001 Van Born Road, Taylor, MI, 48480, US

(21) Appl. No.: 12/333,661

(22) Filed: Dec. 12, 2008

Related U.S. Application Data
(63) Continuation-in-part of application No. 12/025,859, filed on Feb. 5, 2008.

(51) Int. Cl. F16K 31/02

(52) U.S. Cl. 251/129.01

(57) ABSTRACT

A fluid supply monitoring system includes a shutoff valve and an indicator. The shutoff valve selectively blocks a fluid flow. The indicator selectively communicates a signal to the shutoff valve to prevent the shutoff valve from blocking the fluid flow.

### CROSS-REFERENCE TO RELATED APPLICATIONS

This application claims priority as a continuation-in-part to co-pending U.S. patent application Ser. No. 12/025,859, filed Feb. 5, 2008.

### BACKGROUND OF THE DISCLOSURE

This disclosure generally relates to a fluid supply system, and more particularly to a fluid supply monitoring system that monitors a fluid flow through the fluid supply system.

Fluids, such as water and/or gas, are supplied to most residential, commercial and industrial buildings via underground supply lines. The supply lines receive fluid from either a municipal source or a private well, for example. The underground supply lines interconnect with a fluid supply system. The fluid supply system communicates the fluid to a variety of outlets and appliances within the building. For example, the fluid supply system may include a plumbing system that communicates water to toilets, sinks, washing machines, dishwashers and the like.

The fluid supply system typically includes a plurality of supply lines that distribute the fluid to a plurality of locations within a building. The supply lines include a plurality of connections and valves for dividing and distributing the fluid flow.

Fluid supply monitoring systems are known that monitor the fluid flow communicated through a fluid supply system. For example, known fluid supply monitoring systems shutoff a fluid flow in response to a detected leak within the fluid supply system. However, these systems are complicated, and difficult to operate and install within known fluid supply systems.

In addition, many prior art systems improperly shutoff the fluid flow through the fluid supply system during operation of certain appliances that utilize a relatively large amount of fluid. These systems are unable to distinguish between appliances that use a relatively large amount of fluid and appliances that do not use a relatively large amount of fluid.

For example, a plumbing system that includes a water softener may require non-stop fluid flow for up to 150 minutes. Because known fluid supply monitoring systems cannot identify the use of any particular appliance, the system may improperly block the fluid flow through the fluid supply system. This may disrupt the operation of the appliance and is annoying to the user.

Accordingly, it is desirable to provide a fluid supply monitoring system that is simple, inexpensive to operate and install, and that identifies operation of a plurality of appliances associated with a fluid supply system.

### SUMMARY OF THE DISCLOSURE

A fluid supply monitoring system includes a shutoff valve and an indicator. The shutoff valve selectively blocks a fluid flow. The indicator selectively communicates a signal to the shutoff valve to prevent the shutoff valve from blocking the fluid flow in response to receiving the signal.

A method of monitoring a fluid flow through a fluid supply system having a fluid supply monitoring system and at least one appliance includes detecting whether the at least one appliance is in use, communicating a signal to the fluid supply monitoring system in response to detection that the at least one appliance is in use, and preventing blockage of the fluid flow in response to receiving the signal that the at least one appliance is in use.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 illustrates a building including an example fluid supply monitoring system;

FIG. 2 illustrates a cross-sectional view of an example fluid supply monitoring system;

FIG. 3A illustrates an example flow sensor for use within the example fluid supply monitoring system of FIG. 2;

FIG. 3B illustrates an inlet and outlet of the example fluid supply monitoring system illustrated in FIG. 2;

FIG. 3C illustrates an end view of the example flow sensor illustrated in FIG. 3A;

FIG. 3D illustrates a cross-sectional view of the example flow sensor illustrated in FIG. 3A;

FIG. 4 illustrates another example flow sensor for the example fluid supply monitoring system illustrated in FIG. 2;

FIG. 5 illustrates an example circuit board of the fluid supply monitoring system illustrated in FIG. 2;

FIG. 6 illustrates an example housing of the fluid supply monitoring system illustrated in FIG. 2;

FIG. 7 illustrates an exploded view of an example shutoff valve of the fluid supply monitoring system illustrated in FIG. 2;

FIG. 7A illustrates a lever for manually actuating the example shutoff valve illustrated in FIG. 7;

FIG. 8 illustrates an example method for monitoring a fluid supply system;

FIG. 9 illustrates another example method for monitoring a fluid supply system;

FIG. 10 illustrates an example method for testing a fluid supply system;

FIG. 11 illustrates another example fluid supply monitoring system;

FIG. 12 illustrates an example indicator of the fluid supply monitoring system illustrated in FIG. 11;

FIG. 13 illustrates another example indicator of the fluid supply monitoring system of FIG. 11;

FIG. 14 illustrates yet another example indicator of the fluid supply monitoring system illustrated in FIG. 11; and

FIG. 15 illustrates an example method for monitoring a fluid flow through a fluid supply system.

### DETAILED DESCRIPTION OF THE PREFERRED EMBODIMENT

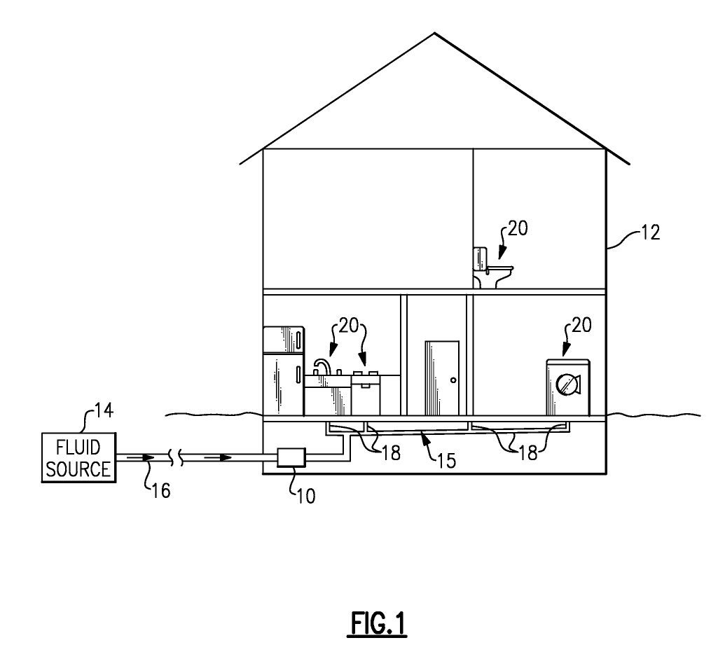

FIG. 1 illustrates a fluid supply monitoring system 10 that monitors the communication of a fluid through a building 12, such as an industrial, commercial or residential building 12, for example. Fluid from a fluid source 14 is communicated to the building via a fluid supply line 16. In one example, the fluid is water. In another example, the fluid is a gas. It should be understood that the example fluid supply monitoring system 10 may be utilized to monitor the flow of any known fluid.

Once in the building 12, the fluid supply line 16 communicates the fluid to a fluid supply system 15. In one example, the fluid supply system 15 is a plumbing system. In another example, the fluid supply system 15 is a gas supply system. A person of ordinary skill in the art having the benefit of this disclosure would be able to implement the example fluid supply monitoring system 10 into any type of fluid supply system to monitor the flow of any fluid type.

The fluid supply system 15 includes a plurality of supply lines 18 that supply the fluid to a plurality of appliances 20, such as sinks, dishwashers, toilets, washing machines, stoves and the like. The fluid supply monitoring system 10 is positioned between the fluid supply line 16 and the fluid supply system 15. In one example, the fluid supply monitoring system 10 is positioned just after ingress into the building 12 for protection from the elements. The fluid supply monitoring system 10 can be positioned in a basement of the building 12, for example.

The fluid supply monitoring system 10 monitors and measures the fluid flow communicated through the fluid supply system 15. In addition, the fluid supply monitoring system 10 is electronically actuable to selectively block fluid flow through the fluid supply system 15, as is further discussed below.

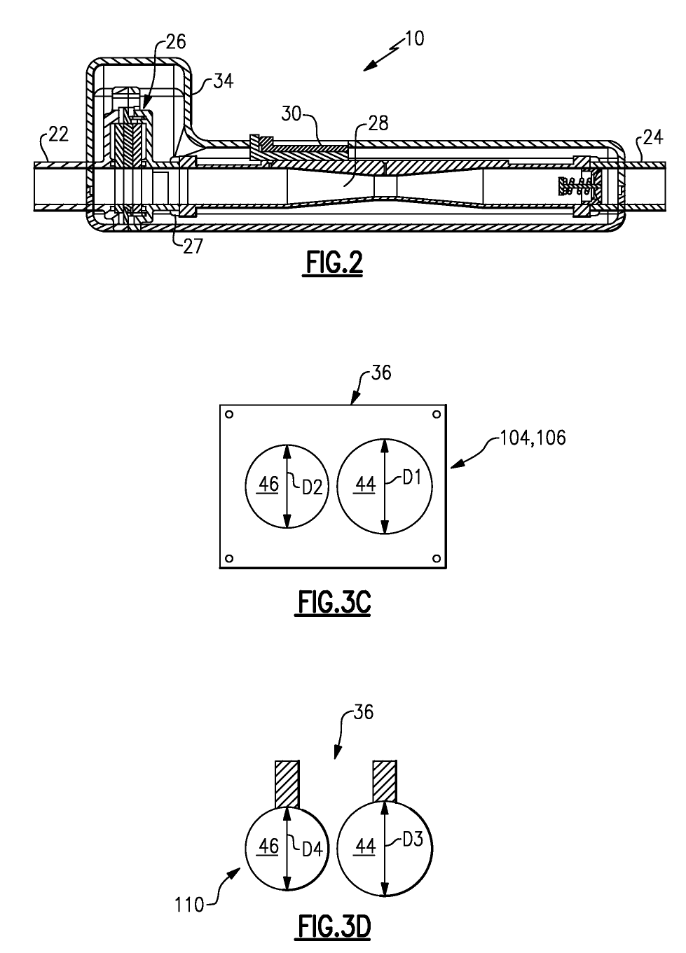

FIG. 2 illustrates an example fluid supply monitoring system 10 that includes an inlet 22, an outlet 24, a shutoff valve 26, a flow straightener 27, a flow sensor 28, a circuit board 30 and a housing 34. The shutoff valve 26, the flow straightener 27, the flow sensor 28 and the circuit board 30 are each substantially encased within the housing 34 when the fluid supply monitoring system 10 is assembled. Under normal fluid flow conditions, the shutoff valve 26 is open to allow fluid flow through the shutoff valve 26 and the flow sensor 28. The fluid flow exits the outlet 24 to enter the fluid supply system 15.

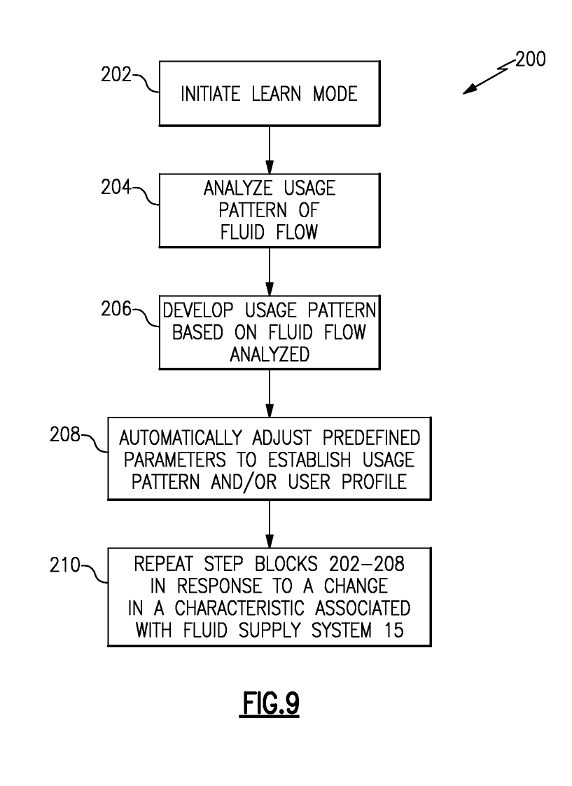

The flow sensor 28 monitors and measures the fluid flow through the fluid supply monitoring system 10, and the circuit board 30 evaluates the fluid flow measured against a plurality of predefined parameters. The shutoff valve 26 is selectively actuable between an open position and a closed position to prevent the communication of the fluid flow through the fluid supply monitoring system 10 in response to any portion of real time fluid flow data of the fluid flow exceeding a corresponding maximum limit stored for each of the plurality of predefined parameters (See method associated with FIG. 8). The fluid supply monitoring system 10 is also capable of leak testing the fluid supply system 15 (See method associated with FIG. 9).

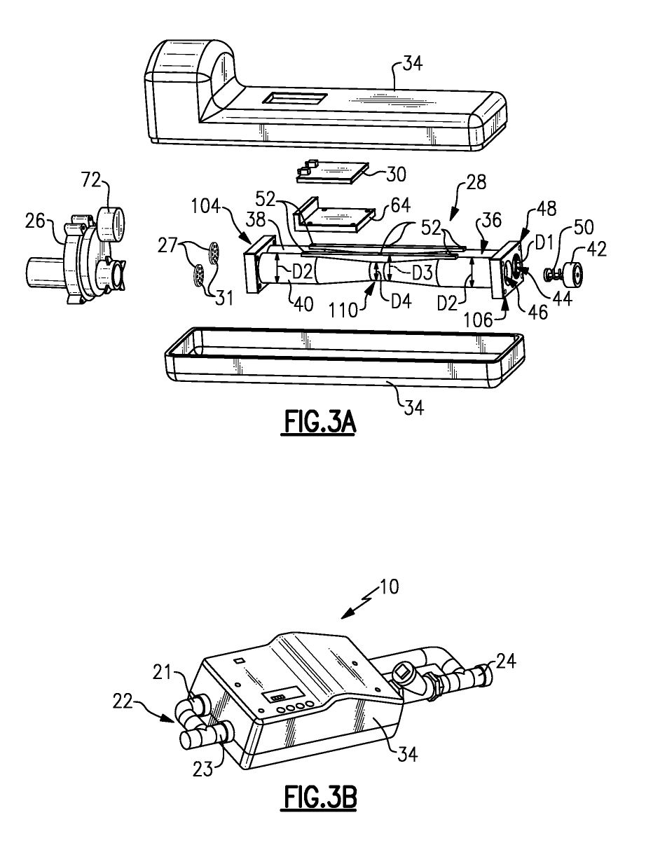

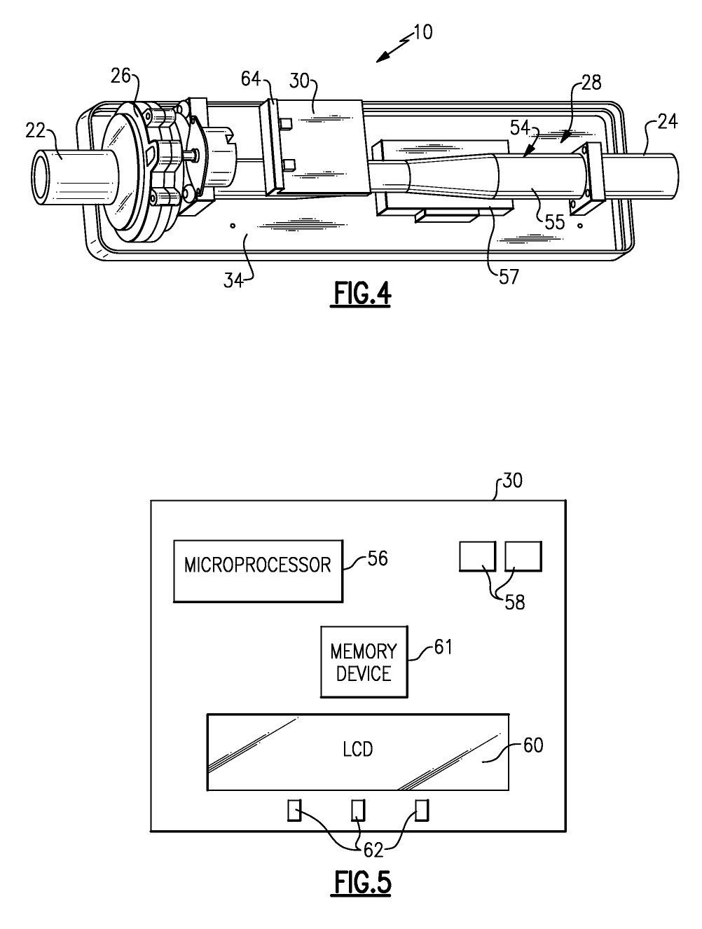

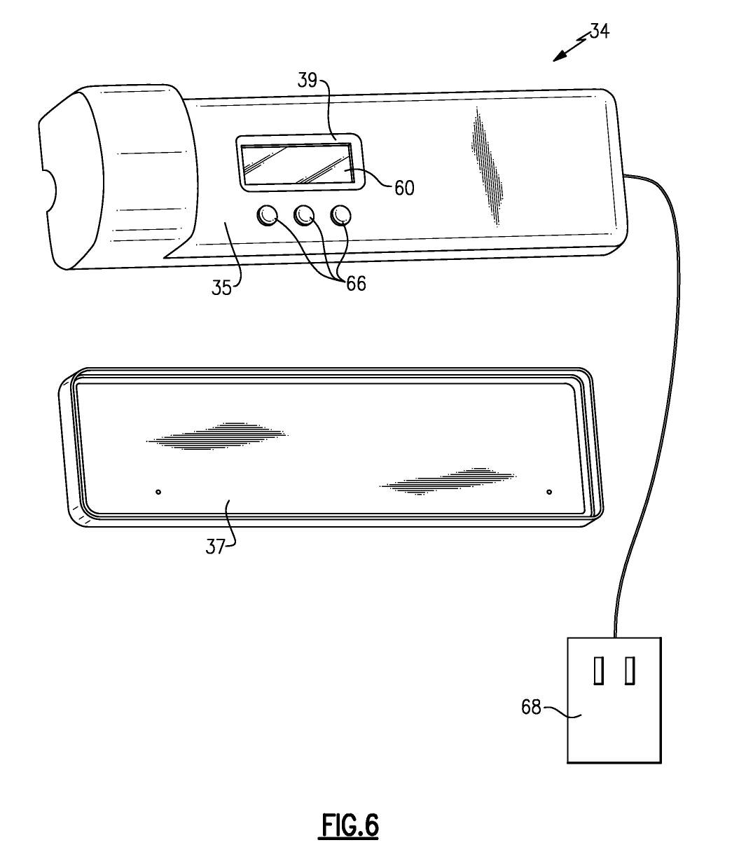

Referring to FIG. 3A, the flow sensor 28 is a dual venturi assembly 36, in one example. The dual venturi assembly 36 includes a first venturi 38, a second venturi 40 and a check valve 42. The first venturi 38 and the second venturi 40 include varying cross-sectional areas. For example, the first venturi 38 includes a passage 44 having first diameters D1 and D3. The second venturi 40 includes a passage 46 having second diameters D2 and D4. An inlet 104 and an outlet 106 of the dual venturi assembly 36 include the diameters D1 and D2 (See FIG. 3C). The diameter D3 and D4 are positioned at a mid-point 110 of the passages 44, 46, in one example (See FIG. 3D).

In one example, the diameter D1 and D3 are larger than the diameters D2 and D4. That is, the first venturi 38 and the second venturi 40 are different sizes such that the first venturi 38 measures a maximum resolution of fluid flow at larger fluid flows, and the second venturi 40 measures a maximum resolution of the fluid flow at lower fluid flows.

The dual venturi assembly 36 is sensitive to the turbulence of the fluid flow communicated through the fluid supply system 15. A flow straightener 27 is positioned at an inlet side 29 of each of the first venturi 38 and the second venturi 40 to reduce the turbulence of the fluid and improve measurement of the fluid flow. In one example, the flow straighteners 27 include a plurality of channels 31 that direct the fluid flow through the venturis 38, 40 to reduce turbulence. The flow straighteners 27 also act as a screen and a filter to prevent debris from clogging the dual venturi assembly 36.

In order to take advantage of the difference between the diameters D1 and D3 and D2 and D4 of the first venturi 38 and the second venturi 40, respectively, the fluid flow is directed through the second venturi 40 at lower fluid flows and is directed through the first venturi 38 only during higher fluid flows. The check valve 42 is positioned at a downstream end 48 of the first venturi 38. The check valve 42 includes a spring 50 that biases the check valve 42 into a closed position to prevent fluid flow from exiting through the first venturi 38 during lower fluid flows. At a low fluid flow, the check valve 42 is held closed by the spring 50 and all fluid flow bypasses the check valve 42 by flowing only through the second venturi 40. A person of ordinary skill in the art having the benefit of this disclosure would be able to select an amount of fluid flow that is sufficient to overcome the biasing force for the check valve 42.

As the demand for fluid flow increases, the biasing force of the spring 50 is overcome by the pressure in the fluid flow to open the check valve 42. In an open position, fluid flow is communicated through both the first venturi 38 and the second venturi 40.

The dual venturi assembly 36 detects and measures fluid flow. The dual Venturi assembly 36 enables measurement of the fluid flow by decreasing the flow path for the fluid flow and measuring the change in pressure from the reduced areas (at diameters D3 and D4) compared to the non-reduced areas (at diameters D1 and D2). The pressure difference is a function of the velocity of the fluid flow. The first venturi 38 and the second venturi 40 include ports 52 for sensing the pressure within the first venturi 38 and the second venturi 40, respectively.

In one example, the fluid flow is divided into two flow paths. Referring to FIG. 3B, the inlet 22 of the fluid supply monitoring system 10 divides the fluid flow into two fluid paths 21, 23. The first fluid path 21 communicates the fluid flow to the first venturi 38, and the second fluid path 23 communicates the fluid flow to the second venturi 40. The outlet 24 recombines the fluid flow communicated through the first venturi 38 and the second venturi 40 into a single fluid flow.

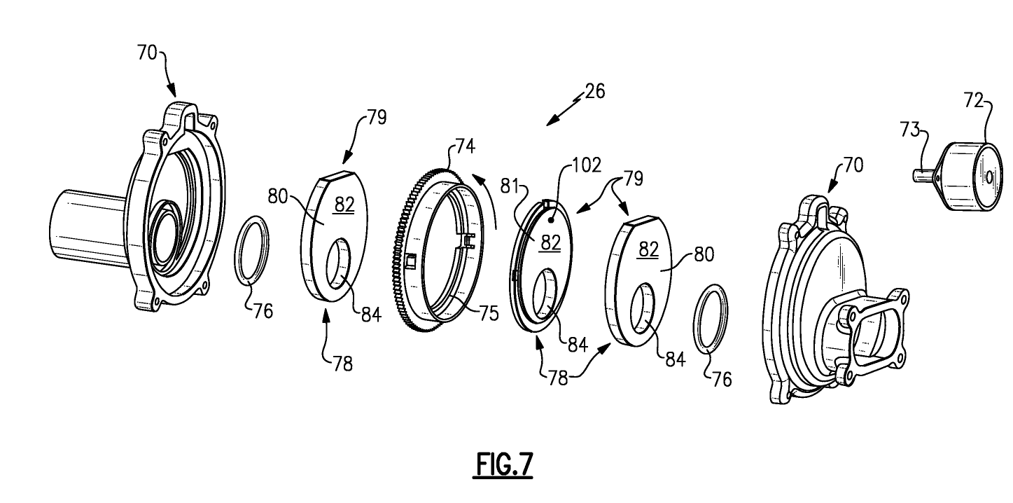

FIG. 4 illustrates another example flow sensor 28 for use within the fluid supply monitoring system 10. In this example, the flow sensor 28 is a magnetic flow meter assembly 54. The magnetic flow meter assembly 54 includes a single fluid passageway 55 and a magnetic flow meter 57. The magnetic flow meter assembly 54 is utilized with the shutoff valve 26, the circuit board 30 and the housing 34 in a similar manner as the dual venturi assembly 36.

The magnetic flow meter 57 is mounted to the fluid passageway 55 at a position downstream relative to the circuit board 30, in this example. Fluid is communicated through the inlet 22 and the shutoff valve 26, and enters the fluid passageway 55. The magnetic flow meter 57 generates a magnetic field across the fluid flow in an area of the fluid passageway 55 that is adjacent to the magnetic flow meter 57. Conductive fluids, such as water for example, contain positive and negative ions. The positive and negative ions are capable of carrying an electrical current.

As a conductive fluid flows through the magnetic field, the positive ions are drawn to a negative side of the magnetic field generated within the fluid flow. In addition, the negative ions are drawn to a positive side of the magnetic field. An electrical potential is measurable by electrical communication between the two magnetic poles. This potential, i.e., voltage, increases between the poles of the magnetic field, and increases proportionally as the speed of the fluid flow increases.

The magnetic flow meter assembly 54 detects and measures fluid flow through the fluid passageway 55. The electrical potentials measured by the magnetic flow meter assembly 54 are communicated to the circuit board 30 for processing into real time fluid flow data, as is further discussed below with respect to FIG. 5.

FIG. 5 schematically illustrates the circuit board 30 for controlling the functionality of the fluid supply monitoring system 10. The circuit board 30 includes a microprocessor 56, pressure transducers 58, an LCD 60, a memory device 61 and a plurality of switches 62. The circuit board 30 is mounted to a mount 64 (See FIG. 3). The mount 64 is further secured to the flow sensor 28, in one example. In one example, the mount is made of a non-conducting plastic.

The pressure transducers 58 convert the differential pressure measurements or the electrical potentials calculated by the flow sensors 36, 54 into a voltage/current data. The voltage/current data from the pressure transducers 58 is communicated to the microprocessor 56 to interpret the voltage/current data into real time fluid flow data. Real time fluid flow data represents a plurality of flow characteristics associated with the fluid flow, including but not limited to, a flow rate of the fluid flow, a flow volume of the fluid flow, and a flow time of the fluid flow.

The microprocessor 56 is programmed with the necessary logic to interpret the voltage/current data and convert the data into the real time fluid flow data. In addition, a plurality of predefined parameters are stored on the microprocessor 56. The plurality of predefined parameters represent an internal set of customizable rules that govern when to actuate the shutoff valve 26. These parameters are compared to the real time fluid flow data calculated by the pressure transducers 58 and the microprocessor 56. A person of ordinary skill in the art having the benefit of this disclosure would be able to program the microprocessor 56 to perform the necessary calculations and comparisons.

In one example, the real time fluid flow data is compared to at least three predefined parameters—the length of time the fluid flow has flown without interruption, the volume of fluid flow that has flown without interruption, and the maximum flow rate of the fluid flow. Each of these three predefined parameters has a maximum limit that, once surpassed, will cause the fluid supply monitoring system 10 to close the shutoff valve 26, as is further discussed below with respect to the method described by FIG. 8.

FIG. 6 illustrates the housing 34 of the fluid supply monitoring system 10. The housing 34 houses and protects the internal components of the fluid supply monitoring system 10. In particular, the housing 34 protects against physical damage, contamination from dust and dirt, water damage, corrosion and external electrical shortage.

The housing 34 includes a top cover 35 and a bottom cover 37. The top cover 35 includes a window 39 for viewing the LCD 60. In addition, a plurality of buttons 66 are positioned on the top cover 35. The buttons 66 interface with the switches 62 of the circuit board 30. A user may view information related to the fluid supply monitoring system 10 on the LCD 60 through the window 39. In one example, the buttons 66 are actuable to command a variety of fluid supply monitoring system 10 functions.

For example, the buttons 66 may include an override button, a learn mode button, a system reset button and/or a leak test button. It should be understood that other system functions may be actuated by the buttons 66. The actual number and type of buttons 66 included on the fluid supply monitoring system will vary depending upon design specific parameters including, but not limited to, the flow requirements of the fluid supply system 15, and a user's preferences.

The fluid supply monitoring system 10 also includes a wall adapter 68 that supplies electrical power to the fluid supply monitoring system 10. In one example, the fluid supply monitoring system 10 utilizes electricity supplied from a 110 volt AC, 60 Hertz outlet. The wall adaptor 68 is a transformer that converts 110 volt AC to 24 volt DC power. The microprocessor 56 and the shutoff valve 26 operate off of the 24 volt DC supply, in one example.

In another example, a hydrogenerator supplies electrical power to the fluid supply monitoring system 10. The hydrogenerator removes the kinetic energy from the fluid flow and transforms the kinetic energy into electrical energy for powering the electronic components of the fluid supply monitoring system 10. In one example, the fluid supply monitoring system 10 includes a plurality of hydrogenerators positioned in-line with the fluid flow to generate a supply of electrical energy. A person of ordinary skill in the art having the benefit of this disclosure would be able to select an appropriate power source to operate the fluid supply monitoring system 10.

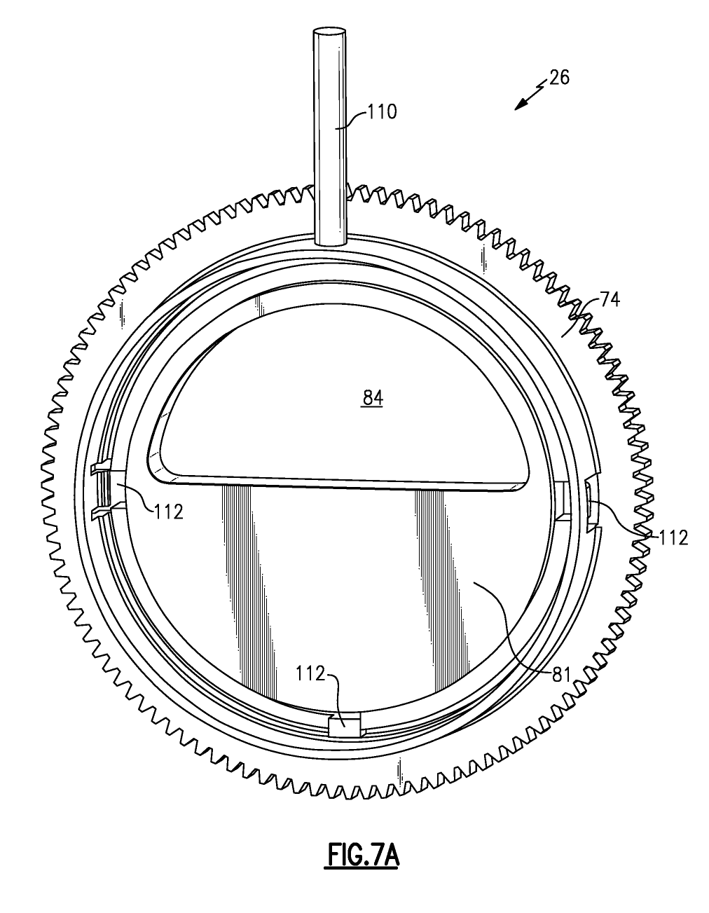

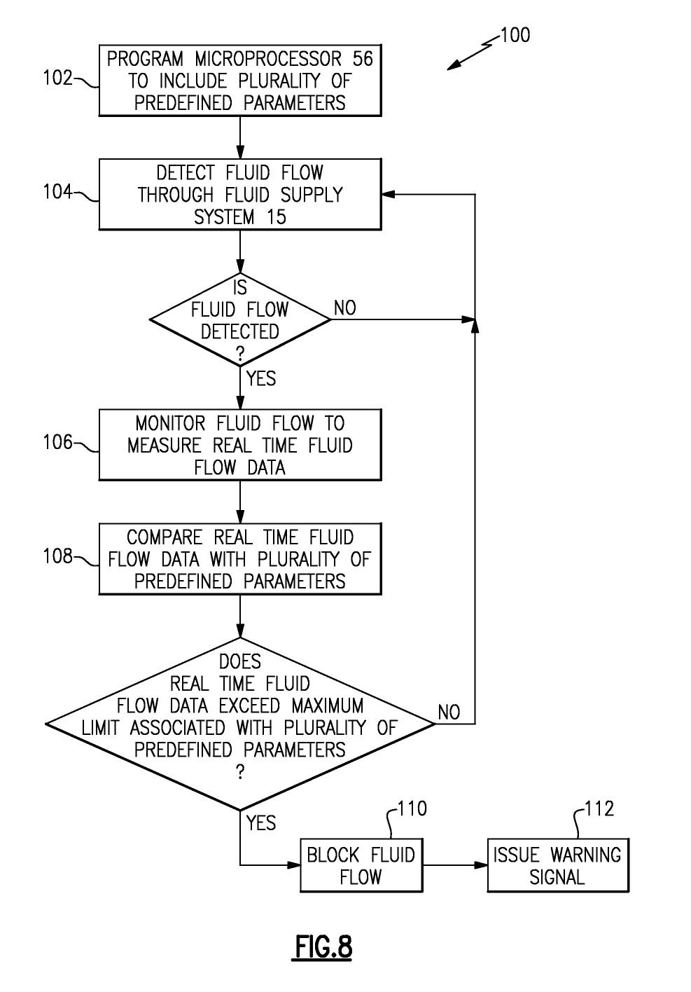

FIG. 7 illustrates an example shutoff valve 26 for use within the fluid supply monitoring system 10. The shutoff valve 26 includes a housing 70, an electric motor 72, a gear ring 74, seal members 76 and a valve assembly 78.

In this example, the valve assembly 78 includes a plurality of plate members 79 that are stacked relative to one another such that a face 82 of each plate member 79 touches the face 82 of an adjacent plate member 79. Each plate member 79 also includes an opening 84. Fluid flow is communicated through the shutoff valve 26 where the openings 84 of each plate member 79 align with one another. That is, the shutoff valve 26 is in an open position where the openings 84 of the plate members 79 are aligned.

In one example, the plate members 79 are made of metal, such as stainless steel, for example. In another example, the plate members 79 are made of a ceramic material. It should be understood that any material that provides a flat surface may be utilized to manufacture the plate members 79.

The shutoff valve 26 is actuable to block the fluid flow through the fluid supply monitoring system 10. In one example, the plate members 79 include a middle plate member 81 and at least two outside plate members 80. The electric motor 72 interfaces with the gear ring 74 to rotate the middle plate member 81 relative to outside plate members 80. The middle plate member 81 is attached to the gear ring 74 at its outer circumference. In one example, the middle plate member 81 is received by a slot 75 of the gear ring 74 in an interference fit.

Rotation of the gear ring 74 via the electric motor 72 is transferred to the middle plate member 81 to move the middle plate member 81 relative to the outside plate members 80. In one example, the electric motor 72 is coupled to the gear ring 74 via a gear train 73. Rotation of the middle plate member 81 relative to the outside plate members 80 causes misalignment of the openings 84 of the plate members 80, 81 relative to one another. Therefore, the fluid flow is prevented from being communicated through the shutoff valve 26

The outside plate members 80 are sealed relative to the housing 70 via seal members 76. The seal members 76 may include washers, O-rings, D-rings, quad-rings or any other type of seal. The housing 70 includes two pieces, in one example, and is assembled by bolts. However, it should be understood that any mechanical means may be utilized to assemble the housing 70.

Although illustrated herein as including a plurality of plate members 79, it should be understood that the valve assembly 78 could include other design configurations. For example, the shutoff valve 26 could be actuated to a closed position with a solenoid valve, a liner motor or any other known valve actuating technology.

A position sensor 102 is located within the shutoff valve 26 to indicate a positioning of the valve assembly 78. In one example, the position sensor 102 is mounted to the middle plate member 81 to monitor the positioning of the middle plate member 81 relative to the outside plate members 80. In another example, the position sensor 102 is mounted to the shutoff valve 26 at any location. The position of the valve assembly 78 is communicated to the microprocessor 56 of the circuit board 30.

As illustrated in FIG. 7A, the shutoff valve 26 is manually actuable between an open position and a closed position. A manual override of the shutoff valve 26 may be necessary during a power outage. In one example, the shutoff valve 26 includes a lever 110 that connects to the gear ring 74. Manipulation of the lever 110 manually moves the gear ring 74. In this example, the middle plate member 81 is attached to the gear ring 74 via a plurality of tabs 112. Therefore, rotation of the gear ring 74 is transferred to the middle plate member 81 to move the middle plate member 81 relative to the outside plate members 80 and align/misalign the openings 84 to selectively allow/disallow fluid flow through the shutoff valve 26.

FIG. 8, with continuing reference to FIGS. 1-7, illustrates an example method 100 for monitoring a fluid supply system 15 with the example fluid supply monitoring system 10. At step block 102, the microprocessor 56 of the circuit board 30 is programmed to include a plurality of predefined parameters related to fluid flow through the fluid supply system 15. In one example, the microprocessor 56 is programmed with maximum limits related to at least the length of time the fluid flow has flown without interruption, the volume of fluid flow that has flow without interruption, and the maximum flow rate of the fluid flow. It should be understood that any parameter related to fluid flow may be programmed within the microprocessor 56.

In one example, the user may select one of a plurality of user profiles that define the plurality of predefined parameters related to the fluid flow of a particular building. The user profiles are stored within the microprocessor and are selectable by a user. The user profiles are also customizable to match the flow requirements for a variety of different fluid supply systems 15. That is, each individual setting/parameter associated with the profile can be altered to match the flow requirements of a particular building 12.

Next, at step block 104, the fluid supply monitoring system 10 detects a fluid flow through the fluid supply system 15. If zero flow is detected, the fluid supply monitoring system 10 continues to monitor the fluid supply system 15 for a fluid flow. Once the fluid flow is detected at step block 104, the fluid supply monitoring system 10 monitors the fluid flow to measure real time fluid flow data at step block 106. For example, the fluid supply monitoring system 10 monitors at least a length of time the fluid flow has flown without interruption, a total volume of the fluid flow that has flown, and a flow rate of the fluid flow in response to detection of the fluid flow. It should be understood that the fluid supply monitoring system 10 is capable of monitoring and measuring any real time fluid flow data.

In one example, the real time fluid flow data is measured by the fluid supply monitoring system 10 with a flow sensor 28 that includes a dual venturi assembly 36. In another example, the fluid supply monitoring system 10 measures the real time fluid flow data with a flow sensor 28 that is a magnetic flow meter assembly 54. The microprocessor 56 utilizes internal logic to interpret the real time fluid flow data received by the dual venturi assembly 36 or the magnetic flow meter assembly 54.

At step block 108, the microprocessor 56 of the fluid supply monitoring system 10 compares the real time fluid flow data measured at step block 106 to the plurality of predefined parameters programmed into the controller at step block 102. In another example, the real time fluid flow data is evaluated against a selected user profile that defines the plurality of predefined parameters related to fluid flow.

Where the data measured at step block 106 exceeds a maximum limit associated with any of the predefined parameter preprogrammed at step block 102, the communication of the fluid flow is prevented through the fluid supply system 15 at step block 110. In one example, the fluid flow is blocked by actuating the shutoff valve 26. The fluid flow is shutoff in response to the length of time the fluid flow has flown without interruption exceeding a predefined maximum length of time, in one example. In another example, the fluid flow is shutoff in response to the total volume of fluid flow that has flown exceeding a predefined maximum flow volume. In yet another example, the fluid flow is shutoff in response to the flow rate associated with the fluid flow exceeding a predefined maximum flow rate.

Finally, at step block 112, a warning signal is issued by the fluid supply monitoring system 10 in response to the fluid flow being shutoff at step block 110. In one example, the warning signal includes both visual and audible signals. For example, an audible signal may be issued by sounding an alarm. In addition, a visual warning may be issued by displaying a message on the LCD 60.

FIG. 9, with continuing reference to FIGS. 1-8, illustrates an example method 200 for monitoring the fluid supply system 15 with the fluid supply monitoring system 10. In this example, the fluid supply monitoring system 10 is capable of entering a “learn mode.” In the learn mode, the fluid supply monitoring system 10 evaluates the real time flow data of the fluid flow to develop a usage pattern of a particular building 12.

At step block 202, a user commands the fluid supply monitoring system 10 to initiate a learn mode. In one example, the learn mode is initiated by actuating a button 66 on the housing 34 of the fluid supply monitoring system 10. When the learn mode is selected, the LCD 60 displays a message indicating that the fluid supply monitoring system 10 has initiated the learn mode.

Next, at step block 204, the fluid supply monitoring system 10 analyzes a usage pattern of the fluid flow associated with the fluid supply system 15 for a predefined period of time. In one example, the usage pattern represents the fluid flow requirements of a particular building 12. The predefined period of time is a period of two weeks, in one example. However, the usage pattern may be analyzed for any period of time.

The fluid supply monitoring system 10 performs as explained with respect to the method 100 to monitor the fluid flow against a plurality of predefined parameters during the learn mode period. At step block 206, and after the predefined period of time has expired, the microprocessor 56 of the fluid supply monitoring system 10 utilizes internal logic to determine the usage profile associated with a particular building 12. In one example, the fluid supply monitoring system 10 automatically adjusts a plurality of predefined parameters associated with the fluid flow in response to analyzing the usage pattern at step block 208. In another example, the fluid supply monitoring system 10 automatically establishes a user profile that defines the usage pattern of the building 12 at step block 208.

Finally, at step block 210, the learn mode is reselected, and step blocks 202-208 are repeated, in response to a change of a characteristic associated with the subject fluid supply system 15. For example, the learn mode could be reselected by a user to restart the predefined period of time for monitoring the building 12 in response to additional/fewer occupants of the building, an added bathroom, a change to water efficient appliances, and the like.

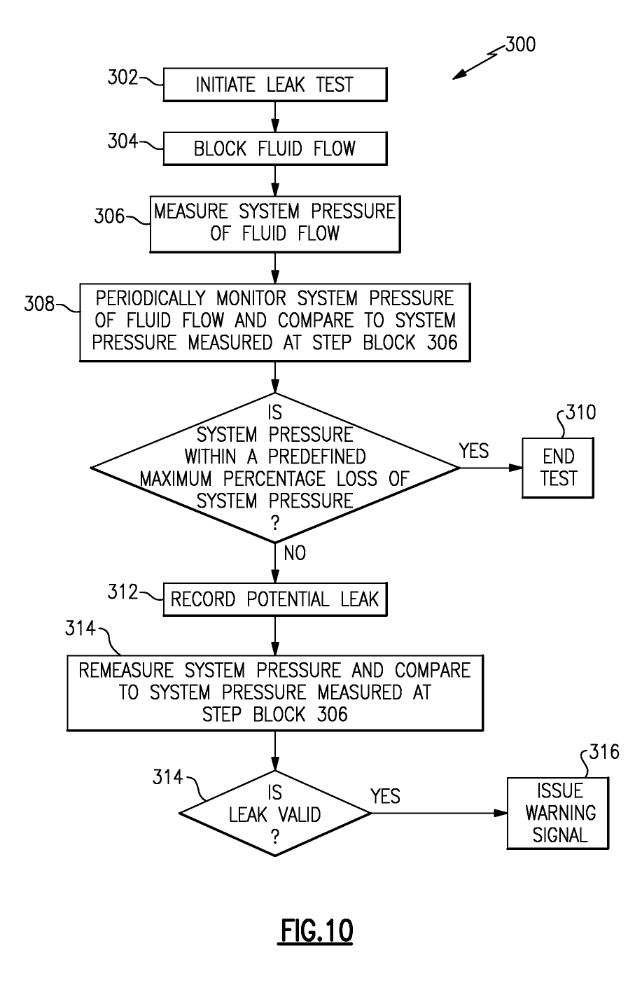

FIG. 10 illustrates an example method 300 for testing the fluid supply system 15 with the fluid supply monitoring system 10. In this example, the fluid supply monitoring system 10 leak tests the fluid supply system 15. The testing is periodically performed by the fluid supply monitoring system 10 at a predefined interval of time. For example, the leak test may be performed once every twenty four hours. It should be understood that the fluid supply monitoring system 10 may be programmed to perform a leak test of the fluid supply system 15 at any desired interval of time.

The method begins at step block 302 where a user initiates the leak test. In one example, the leak test is initiated by actuating a button 66 on the housing 34 of the fluid supply monitoring system 10. Once the button 66 is actuated, a leak test message is displayed on the LCD 60 of the fluid supply monitoring system 10. Next, at step block 304, the fluid supply monitoring system 10 prevents the passage of the fluid flow through the fluid supply system 15. In one example, the fluid flow is prevented from communication to the fluid supply system 15 by actuating, i.e., closing, the shutoff valve 26.

Immediately subsequent to actuating the shutoff valve 26, a system pressure associated with the fluid flow is measured at a position that is downstream from the shutoff valve 26 at step block 306. The measured system pressure is stored for subsequent comparison. The system pressure is measured with a pressure monitoring device. In one example, the pressure monitoring device includes pressure transducers 58 positioned on the circuit board 30. In another example, a plurality of pressure transducers 58 may be positioned within the fluid flow, such as within the supply lines 18, for example.

At step block 308, the system pressure of the fluid flow within the fluid supply system 15 is periodically measured for a predefined period of time. In addition, each system pressure is compared to the system pressure measured at step block 306. In one example, the system pressure is measured six times per minute for a period of time of ten minutes. However, the system pressure may be monitored and compared for any period of time and at any frequency during that period of time.

If each of the system pressures measured at step block 308 is within a predefined maximum percentage loss of the system pressure measured at step block 306, the fluid supply system 15 is considered leak free and the test ends at step block 310. The predefined maximum percentage loss is measured from the system pressure obtained at step block 306. In one example, the predefined maximum percentage loss of system pressure is 10%. That is, the fluid supply system 15 is considered leak free where the system pressures measured at step block 308 are less then or equal to 10% below the system pressure measured at step block 306.

A potential leak in the fluid supply system 15 is recorded by the fluid supply monitoring system 10 at step block 312 in response to any of the system pressures measured at step block 308 exceeding the maximum predefined percentage loss of the system pressure measured at step block 306. That is, the potential leak is recorded in response to any system pressure measured at step block 308 being greater than 10% less than the system pressure measured at step block 306, for example.

Optionally, at step block 314, the system pressure is again measured and compared to the system pressure measured at step block step block 306 to determine whether a true leak exists. If again the leak is sensed, the shutoff valve 26 is opened and a warning signal is issued at step block 316.

If the system pressure of the fluid flow reduces faster than a predetermined rate, the fluid supply monitoring system 10 assumes that there is a downstream demand for fluid flow, such as a toilet flush, for example. This causes the shutoff valve 26 to reopen, and the leak testing is delayed for a period of time. In one example, the fluid supply monitoring system 10 prevents the communication of fluid flow through the fluid supply system 15 in response to a number of delayed testing sequences.

FIG. 11 illustrates another example fluid supply monitoring system 101. The fluid supply monitoring system 101 is substantially similar to the fluid supply monitoring system 10. However, in this example, an indicator 103 communicates with the fluid supply monitoring system 101. The indicator 103 communicates in-use status information of an appliance 107 associated with the fluid supply system 109 to the fluid supply monitoring system 101, for example.

The fluid supply monitoring system 101 operates as described above to selectively block a fluid flow through the fluid supply system 109 in response to real time fluid flow data exceeding a maximum limit associated with any predefined parameters stored within the fluid supply monitoring system 101. For example, the fluid flow is blocked in response to a length of time the fluid flow has flown without interruption exceeding a maximum limit associated with the length of time the fluid flow has flown without interruption.

The indicator 103 communicates with a shutoff valve 105 of the fluid supply monitoring system 101. The shutoff valve 105 of the fluid supply monitoring system 101 is prevented from blocking the fluid flow through the fluid supply system 109 in response to receiving a signal from the indicator 103, as is further discussed below. That is, the fluid flow is permitted to flow through a fluid supply system 109 notwithstanding the real time fluid flow data exceeding a maximum limit associated with any of the plurality of pre-defined parameters in response to receiving the signal from the indicator 103.

In one example, the indicator 103 communicates the signal to the fluid supply monitoring system 101 in response to sensing operation of an appliance 107 that is associated with the fluid supply system 109. The indicator 103 is in fluid communication with the appliance 107. In one example, the appliance 107 is a water softener. In another example, the appliance 107 is a reverse osmosis water filter.

It should be understood that the example indicator 103 is operable to detect the operation of any appliance 107 that is associated with the fluid supply system 109. Although only a single indicator 103 and a single appliance 107 are illustrated with respect to FIG. 11, it should be understood that the fluid supply monitoring system 101 may include any number of indicators 103 that provide in-use status information of a plurality of appliances 107.

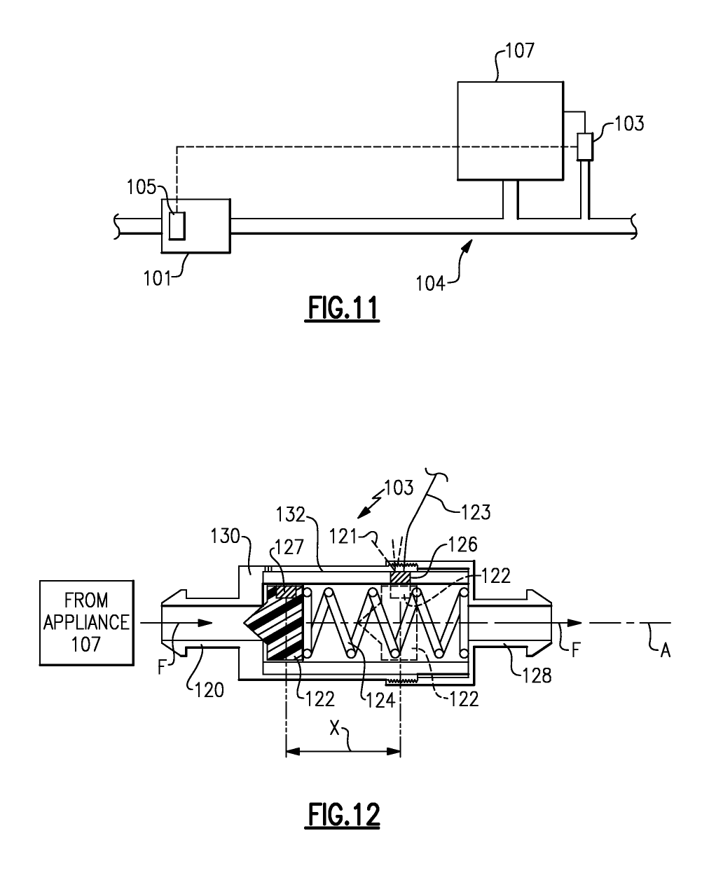

FIG. 12 illustrates a first example indicator 103 that communicates with the fluid supply monitoring system 101. The example indicator 103 includes an inlet 120, a poppet valve 122, an elastic member 124, a magnet 126 and an outlet 128. A housing 130 substantially surrounds the inlet 120, the poppet valve 122, the elastic member 124, the magnet 126 and the outlet 128.

In operation, a fluid flow F (from an appliance 107) is communicated through the inlet 120 and contacts the poppet valve 122. The force of the fluid flow F axially displaces the poppet valve 122 along a longitudinal axis A of the housing 130 in a direction toward the outlet 128 (displacement shown in phantom). In one example, the elastic member 124 is a spring and the force of the fluid flow F overcomes the biasing force of the spring to displace the poppet valve 122. In this example, the magnet 126 is mounted within a flange 132 of the housing 130. A corresponding magnet 127 is mounted to the poppet valve 122. In one example, the magnets 126 are reed switches.

The indicator 103 communicates an in-use signal to the fluid supply monitoring system 101 in response to displacement of the poppet valve 122 by a distance X (or greater than a distance X). At the displacement distance X, the magnet 127 of the poppet valve 122 is aligned with the magnet 126 mounted to the flange 132 (shown in phantom to indicate displacement of the poppet valve 122). Alignment of the magnets 126, 127 triggers the communication of the in-use signal to the fluid supply monitoring system 101. A person of ordinary skill in the art having the benefit of this disclosure would be able to select an appropriate displacement distance X of the poppet valve 122 for triggering the communication of the in-use signal of an appliance 107.

In one example, the in-use signal is communicated from the indicator 103 to the fluid supply monitoring system 101 via wireless communication signals 121. In another example, the in-use signal is communicated from the indicator 103 to the fluid supply monitoring system 101 via a hard-wired connection 123. A person of ordinary skill in the art having the benefit of this disclosure would be able to select an appropriate method for communicating the in-use signal. In addition, a person of ordinary skill in the art would be able to implement the necessary components within the indicator 103 and the fluid supply monitoring system 101 for sending, receiving, and analyzing the in-use signals.

Referring to FIG. 13, the indicator 103 may include a plurality of magnets 126 for sensing the displacement of the poppet valve 122. In this example, three magnets 126A-126C are mounted to the flange 132. It should be understood that any number of magnets 126 may be utilized to detect the displacement of the poppet valve 122. The magnets 126 are reed switches, in one example.

Depending upon the amount of fluid flow F that is communicated through the inlet 120 of the indicator 103, the poppet valve 122 is displaced along the longitudinal axis A. Based upon the amount of displacement, the indicator 103 communicates in-use status information of an appliance 107.

In addition, in this example, the indicator 103 communicates flow rate information of the fluid flow F that is communicated through the indicator 103 based upon the actual displacement distance X1-X2 of the poppet valve 122. For example, where the magnet 127 of the poppet valve 122 aligns with the magnet 126A, the poppet valve 122 does not displace. Therefore, the appliance 107 is considered off and no signal is communicated to the fluid supply monitoring system 101.

The poppet valve 122 is displaced a distance X1 where the magnet 127 aligns with the magnet 126B. At the distance X1 or less, the flow rate of the fluid flow F is considered too low to communicate an in-use signal, for example. Therefore, the fluid supply monitoring system 101 operates under normal conditions to selectively block the fluid flow though the fluid supply system 109.

In yet another example, the magnet 127 of the poppet valve 122 may align with the magnet 126C such that the poppet valve 122 is displaced a distance X2 (or greater than a distance X2). At this distance (or beyond this distance), the indicator 103 communicates a signal to the shutoff valve 105 to prevent blockage of the fluid flow F, and also communicates the flow rate of the fluid flow F to the fluid supply monitoring system 101. A specific flow rate will be associated with the displacement distance X2, for example.

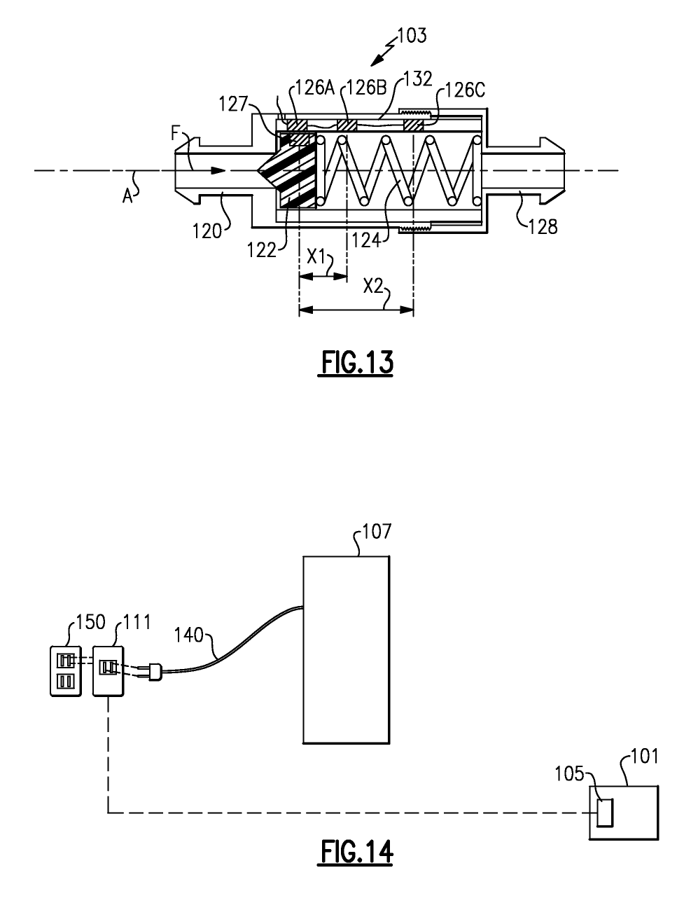

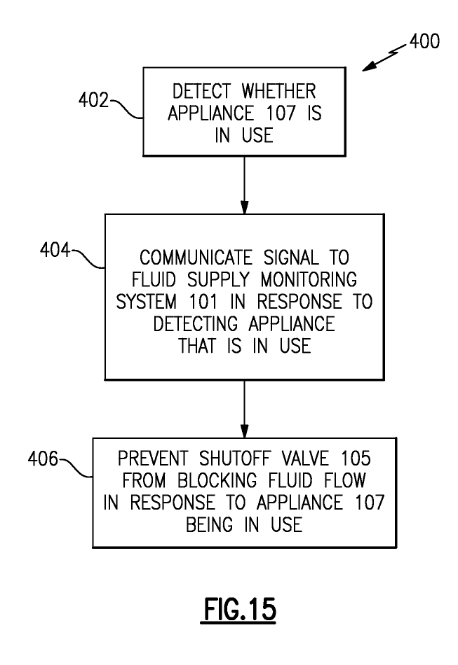

FIG. 14 illustrates a second example indicator 111 for use with the fluid supply monitoring system 101. In this example, the indicator 111 is a plug-in type indicator that senses an electrical power draw of an appliance 107 to determine whether the appliance 107 is in-use. In this example, the indicator 111 is located between an electrical cord 140 of the appliance 107 and an electrical outlet 150.

Where an electrical power draw of the appliance 107 is sensed by the indicator 111, the indicator 111 communicates with the shutoff valve 105 of the fluid supply monitoring system 101 to prevent blockage of a fluid flow through the fluid supply system 109. In one example, the indicator 111 communicates wirelessly with the fluid supply monitoring system 101. In another example, the indicator 111 communicates with the fluid supply monitoring system 101 via a hard-wired connection.

FIG. 15, with continued reference to FIGS. 11-14, illustrates an example method 400 for monitoring a fluid flow through a fluid supply system 109 that includes a fluid supply monitoring system 101 and one or more appliances 107. At step block 402, the indicator 103 (or 111) detects whether the appliance(s) 107 is in use. In one example, the example indicator 103 detects whether the appliance 107 is in use. For example, the appliance 107 is considered in use where the poppet valve 122 is displaced a distance X and the magnet 127 of the poppet valve 122 aligns with the magnet 126 mounted on the flange 132 of the housing 130 (See FIG. 12). In another example, the example indicator 111 detects whether the appliance 107 is in-use by sensing an electrical power draw of the appliance 107 (See FIG. 14).

Next, at step block 404, the indicator 103/111 communicates a signal to the fluid supply monitoring system 101 in response to detection that the appliance 107 is in use. In one example, the signal is wirelessly communicated. In another example, the signal is communicated over a hard-wired connection between the indicator 103/111 and the fluid supply monitoring system 101.

Finally, at step block 406, the shutoff valve 105 of the fluid supply monitoring system 101 is prevented from blocking the fluid flow through the fluid supply system 109 in response to receiving the signal from the indicator 103 that the appliance 107 is in use. The shutoff valve 105 is prevented from blocking the fluid flow for the entire period of time the appliance 107 is sensed as in-use.

The foregoing description shall be interpreted as illustrative and not in any limiting sense. A worker of ordinary skill in the art would recognize that certain modifications would come within the scope of this invention. For these reasons, the following claims should be studied to determine the true scope and content of this invention.

What is claimed is:

1. A fluid supply monitoring system, comprising:
a shutoff valve that selectively blocks a fluid flow; and
an indicator that selectively communicates a signal to said shutoff valve, wherein said shutoff valve is prevented from blocking the fluid flow is response to receiving said signal.

2. The system as recited in claim 1, wherein said indicator communicates said signal in response to operation of an appliance associated with the fluid supply monitoring system.

3. The system as recited in claim 2, wherein the appliance is a water softener.

4. The system as recited in claim 2, wherein the appliance is a reverse osmosis water filter.

5. The system as recited in claim 1, wherein said indicator includes a housing, a poppet valve positioned within said housing, and at least one magnet.

6. The system as recited in claim 5, wherein said poppet valve is axially displaceable along a longitudinal axis of said housing in response to communication of a fluid flow through said housing.

7. The system as recited in claim 5, wherein said at least one magnet includes a plurality of magnets, and said plurality of magnets sense a position of said poppet valve.

8. The system as recited in claim 7, wherein said signal is communicated to said shutoff valve in response to a magnet of said poppet valve aligning with one of said plurality of magnets.

9. The system as recited in claim 1, wherein said indicator is positioned in fluid communication with an appliance.

10. The system as recited in claim 1, wherein said indicator includes a plug-in indicator that senses an electrical power draw of an appliance.

11. The system as recited in claim 10, wherein said plug-in indicator is positioned between an electrical cord of said appliance and an electrical outlet.

12. The system as recited in claim 10, wherein said indicator communicates said signal to said shutoff valve is response to sensing said electrical power draw.

13. A method of monitoring a fluid flow through a fluid supply system having a fluid supply monitoring system and at least one appliance, comprising the steps of:
a) detecting whether the at least one appliance is in use;
b) communicating a signal to the fluid supply monitoring system in response to detection that the at least one appliance is in use; and
c) preventing blockage of the fluid flow in response to receiving the signal that the at least one appliance is in use.

14. The method as recited in claim 13, wherein an indicator is in communication with the fluid supply monitoring system, and said step a) includes the step of:
detecting a fluid flow through the indicator.

15. The method as recited in claim 13, wherein said step a) includes the step of:
sensing an electrical power draw of the at least one appliance.

16. The method as recited in claim 13, wherein said step b) includes the step of:
wirelessly communicating the signal.

17. The method as recited in claim 13, wherein said step b) includes the step of:
communicating the signal over a hard-wired connection.

18. The method as recited in claim 13, comprising the step of:
preventing the blockage of the fluid flow for an entire period of time the at least one appliance is in use.

19. The method as recited in claim 13, wherein the at least one appliance includes a plurality of appliances, and said step a) includes the step of:
detecting whether each of the plurality of appliances is in use.
